(19) United States
(12) Patent Application Publication
(10) Pub. No.: US 2016/0334776 A1
(43) Pub. Date: Nov. 17, 2016

(54) DRAWING APPARATUS AND CONTROL SYSTEM

(71) Applicant: MITSUBISHI ELECTRIC CORPORATION, Tokyo (JP)

(72) Inventors: Yukihiro HANAKI, Aichi (JP); Koichiro HIROTA, Aichi (JP)

(73) Assignee: Mitsubishi Electric Corporation, Tokyo (JP)

(21) Appl. No.: 15/112,609

(22) PCT Filed: Feb. 12, 2014
(86) PCT No.: PCT/JP2014/053213

§ 371 Date: Jul. 19, 2016

(51) Int. Cl. G05B 19/05; G05B 23/02

(52) U.S. Cl. CPC G05B 19/058; G05B 23/0272; G05B 23/0264

(57) ABSTRACT

A drawing apparatus that creates drawing data to be executed by a programmable display device connected to an external device includes a project-data creation unit, a project-data transfer unit, a diagnostic-information generation unit that generates diagnostic information, and an obtaining-information holding unit that holds therein error-obtaining information for obtaining error information. In the obtaining-information holding unit, the error-obtaining information about each of external devices that are connectable to the programmable display device is registered, when an external device, to be connected to the programmable display device, is selected from among the external devices, the diagnostic-information generation unit reads error-obtaining information about a selected external device, registered in the obtaining-information holding unit, and generates the diagnostic information by using the read error-obtaining information. The project-data transfer unit transfers the project data that includes the diagnostic information generated by the diagnostic-information generation unit to the programmable display device.

### FIELD

The present invention relates to a drawing apparatus and a control system.

### BACKGROUND

There is a commonly-known programmable display device to which an external device such as a programmable logic controller (PLC) is connected. When some problem occurs in the external device, the programmable display device displays, for example, a default error message in some cases. The error message is, for example, displayed simply to annunciate the occurrence of the error, but does not include a display through which an operator of the programmable display device can identify the state of the external device in detail. The operator can only know a considerably limited amount of information regarding the occurrence of problems in the external device from the programmable display device.

In some cases, a user who creates drawing data on the programmable display device assumes the occurrence of a problem in the external device, and prepares in advance a program for obtaining and displaying detailed information on the external device. The user creates a program dedicated to each external device. The created program is included in project data stored in the programmable display device. When a problem has occurred in the external device, the programmable display device executes the program, and displays information on the external device. In this case, each time a change is required in the configuration of the external device, a user needs to reprogram and verify the program after its reprogramming. This results in a problem that a considerable amount of cost, time, and effort is required to prepare the program.

In some cases, an operator of the programmable display device connects a peripheral device, having diagnostic software for an external device installed therein, to the external device, thereby obtaining detailed information on the external device. The operator prepares software dedicated to each external device. When a plurality of external devices are connected to the programmable display device, the operator needs to connect a peripheral device, having the dedicated software installed therein, to each of the external devices in order to obtain information from each of the external devices. This results in a problem that much time and effort is required to obtain the information from each of the external devices. Further, it may be difficult to provide a peripheral device near the external device.

There is a case where when the programmable display device and the external device use different units from each other to obtain information, an operator may be assigned with associating the obtained information with each other. Depending on the operator's experience and proficiency, a considerable amount of time and effort may be required to identify the cause of a problem.

Although the operator can obtain detailed information on the external device, depending on the circumstances such as when the operator does not have accessible project data that the programmable display device uses, or when the specifications of the external device are not clear, the operator does not know how to proceed with the specific analysis. This makes it difficult to promptly handle the problem. For example, in a programmable display device and an external device which have been in operation over a long duration, a problem can often occur, which is difficult to promptly handle due to the factors such as the absence of the person who is responsible for creating the drawing data, or the loss of material data.

For example, Patent Literature 1 discloses the technique to extract desired data from the existing project data and to use the extracted data so as to generate a database for reuse.

### CITATION LIST

### Patent Literature

Patent Literature 1: Japanese Patent Application Laid-open No. 2012-155367

### SUMMARY

### Technical Problem

A control system including a programmable display device and an external device is made capable of easily obtaining detailed information regarding a problem when a problem has occurred to the operation of the control system, and it is therefore required to work efficiently on figuring out the cause of the problem so as to resume the operation.

The present invention has been made to solve the above problems, and an objective of the present invention is to provide a drawing apparatus and a control system that are capable of easily obtaining detailed information regarding a problem when occurring to a control system that includes a programmable display device and an external device and that can work efficiently on figuring out the cause of the problem so as to resumes the operation.

### Solution to Problem

In order to solve the problem and achieve the objective, the present invention relates to a drawing apparatus that creates drawing data to be executed by a programmable display device connected to an external device. The drawing apparatus includes a project-data creation unit that creates project data that is a basis for the drawing data; a project-data transfer unit that transfers the project data created by the project-data creation unit to the programmable display device; a diagnostic-information generation unit that generates diagnostic information for diagnosing an operational state of the external device on the basis of the diagnostic information; and an obtaining-information holding unit that holds therein obtaining-information for obtaining error information indicating an occurrence of an error in the external device. The obtaining-information about each of external devices that are connectable to the programmable display device is registered in the obtaining-information holding unit. When an external device that is connected to the programmable display device is selected from among the external devices, the diagnostic-information generation unit reads the obtaining-information about the selected external device, which is registered in the obtaining-information holding unit, and generates the diagnostic information by using the read obtaining-information, and the project-data transfer unit transfers the project data that includes the diagnostic information generated by the diagnostic-information generation unit to the programmable display device.

### Advantageous Effects of Invention

The drawing apparatus of the present invention uses error-obtaining information registered in advance to generate diagnostic information. Without preparing a program for obtaining and displaying detailed information about an external device, the drawing apparatus can create diagnostic information for diagnosing the external device. Even in the case where there is a change in the configuration of the external device, the drawing apparatus can still easily create diagnostic information for diagnosing the external device after being changed in the configuration. Without preparing diagnostic software for an external device, the drawing apparatus can diagnose the operational state of the external device on the basis of the diagnostic information. On the basis of the obtained diagnostic result, the drawing apparatus further retrieves the diagnostic information to continue the diagnosis and therefore can also efficiently figure out the cause of an error attributable to the states of a plurality of external devices. With this configuration, the drawing apparatus is capable of easily obtaining detailed information regarding a problem having occurred in the control system and therefore can work efficiently on figuring out the cause of the problem so as to resume the operation.

### BRIEF DESCRIPTION OF DRAWINGS

FIG. 1 is a block diagram illustrating a control system including a drawing apparatus according to a first embodiment of the present invention.

FIG. 2 is a block diagram illustrating a configuration of a programmable display device included in the control system illustrated in FIG. 1.

FIG. 3 is a block diagram illustrating a configuration of diagnostic information.

FIG. 4 is a flowchart illustrating an example of a procedure to generate the external-device diagnostic information.

FIG. 5 is an explanatory diagram of an example of project data.

FIG. 6 is a diagram illustrating an example of a screen displayed by a programmable display device according to the project data illustrated in FIG. 5.

FIG. 7 is a diagram illustrating an example of the project diagnostic information.

FIG. 8 is a diagram illustrating an example of the external-device diagnostic information.

FIG. 9 is a diagram illustrating an example of the error-obtaining information.

FIG. 10 is a diagram illustrating an example of an error-detail information table.

FIG. 11 is a diagram illustrating an example of the user-designated error information.

FIG. 12 is a diagram illustrating an example of the diagnostic information.

FIG. 13 is a flowchart illustrating an example of a procedure to diagnose an operational state of an external device by using the diagnostic information.

FIG. 14 is a block diagram illustrating a control system that includes a drawing apparatus and a diagnostic apparatus according to a second embodiment of the present invention.

FIG. 15 is a block diagram illustrating a configuration of a computer as the drawing apparatus included in the control system illustrated in FIG. 14.

FIG. 16 is a block diagram illustrating a configuration of a portable communication device as the diagnostic apparatus included in the control system illustrated in FIG. 14.

FIG. 17 is an explanatory diagram of a transition of an error check screen.

FIG. 18 is an explanatory diagram of a transition of a diagnostic screen.

### DESCRIPTION OF EMBODIMENTS

Exemplary embodiments of a drawing apparatus and a control system according to the present invention will be explained below in detail with reference to the accompanying drawings. The present invention is not limited to the embodiments.

### First Embodiment

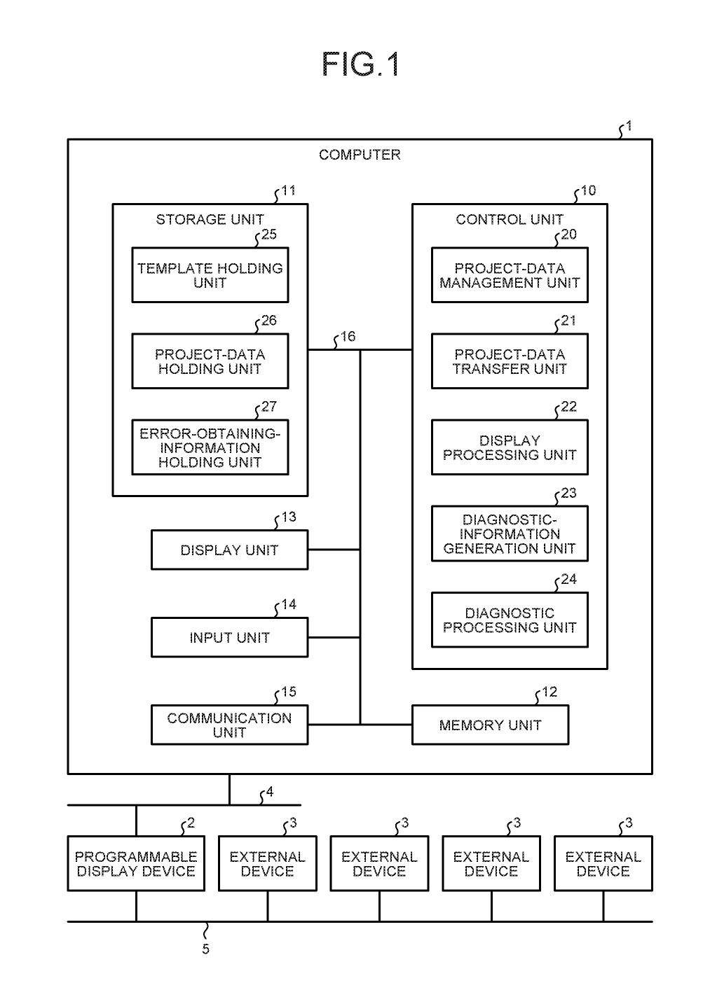

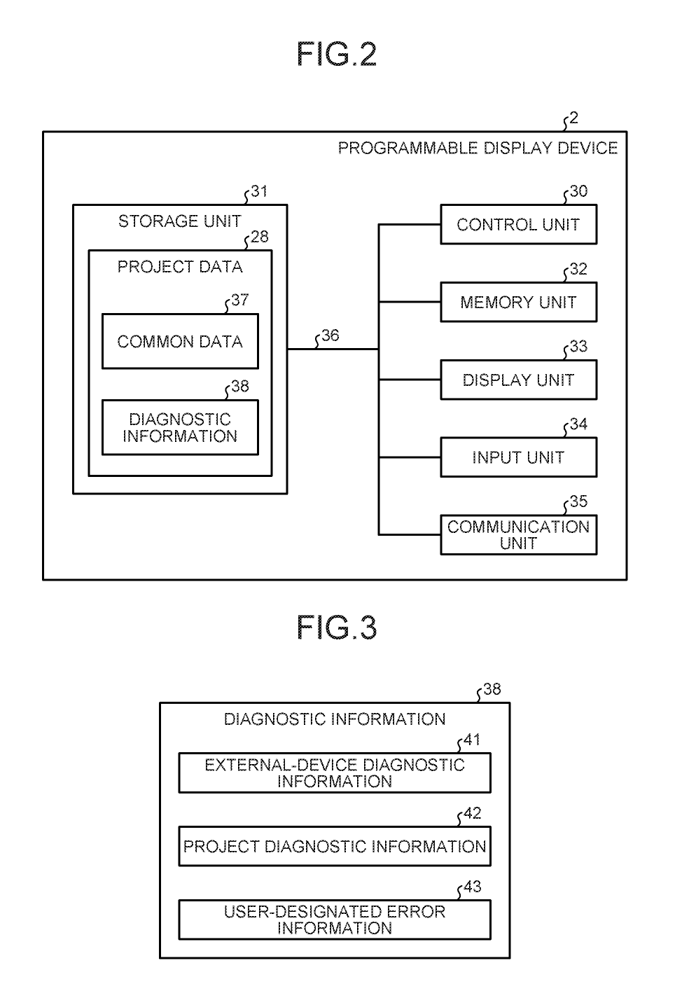

FIG. 1 is a block diagram illustrating a control system including a drawing apparatus according to a first embodiment of the present invention. FIG. 2 is a block diagram illustrating a configuration of a programmable display device included in the control system illustrated in FIG. 1. The control system includes a computer 1, a programmable display device 2, and external devices 3.

In the present embodiment, a user refers to a user of drawing-software. The user uses the drawing software to design the screen of the programmable display device 2. An operator refers to a person who operates the control system, including the operation of the programmable display device 2.

The computer 1 is hardware having the drawing software installed therein. The drawing apparatus of the present embodiment is the computer 1 having the drawing software installed therein. The drawing software has a function to create drawing data. The drawing data is design data for the screen to be displayed on the programmable display device 2. The computer 1 creates drawing data to be executed by the programmable display device 2 according to the user operations. The computer 1 supplies the drawing data to the programmable display device 2.

The programmable display device 2 displays a screen according to the drawing data supplied from the computer 1. The programmable display device 2 receives an operation from an operator via the screen, and it controls the external device 3 according to the received operation. The programmable display device 2 has a function as a user interface for the external device 3.

The computer 1 and the programmable display device 2 are connected via a network 4 so as to be able to communicate with each other. The network 4 is a communication network using, for example, the Ethernet®. The network 4 can also be another communication network that is either a wireless network or a wired network that uses RS-232, a USB, or the like.

The control system includes four external devices 3, for example. The external device 3 is, for example, a programmable controller. A controlled device is further connected to this programmable controller. The programmable controller controls the controlled device according to the sequence program. The external device 3 can also be a device other than the programmable controller, for example, a sensor.

The external devices 3 provided in the control system are all connected to the programmable display device 2. The programmable display device 2 and each of the external devices 3 are connected via a network 5 so as to be able to communicate with each other.

Any number of the external devices 3 can be provided in the control system. The number of the external devices 3 is not limited to four. In the control system, one or more external devices 3 can be connected to the programmable display device 2. The network 5 can be either a wireless-communication network or a wired-communication network.

The computer 1 includes a control unit 10, a storage unit 11, a memory unit 12, a display unit 13, an input unit 14, and a communication unit 15. The control unit 10, the storage unit 11, the memory unit 12, the display unit 13, the input unit 14, and the communication unit 15 are connected via a bus 16 so as to be able to communicate with each other. Each function included in the drawing software is performed by using the control unit 10 and the storage unit 11.

The control unit 10 is a central processing unit (CPU). The control unit 10 controls the entire computer 1. The control unit 10 performs the function of the drawing software according to a start-up command given by a user. For example, the control unit 10 displays a predetermined editing screen on the display unit 13 according to the function of the drawing software. The storage unit 11 is a hard disk drive, a semiconductor storage device, or the like. The storage unit 11 stores therein various programs and data.

The memory unit 12, which is a volatile memory, is used as a working memory for the control unit 10 to execute a calculating process. The display unit 13 is a display unit that displays a screen according to the control executed by the control unit 10. The display unit 13 is, for example, a liquid crystal display. The input unit 14 is a keyboard, a pointing device, and the like that receive an input operation for the computer 1. The communication unit 15 transmits and receives information to and from the programmable display device 2 via the network 4.

The control unit 10 includes a project-data management unit 20, a project-data transfer unit 21, a display processing unit 22, a diagnostic-information generation unit 23, and a diagnostic processing unit 24. The project-data management unit 20, which is a project-data creation unit, creates project data according to the user operation input to the input unit 14. The project-data management unit 20 manages project data 28 input to the computer 1 from the programmable display device 2.

The project-data transfer unit 21, which is a project-data transfer unit, transfers the project data 28 created by the project-data management unit 20 to the programmable display device 2. The display processing unit 22 executes a process of generating a display on the display unit 13. For example, the display processing unit 22 executes a process of monitoring creation of the project data 28 in the project-data management unit 20. The display processing unit 22 executes a process of generating a display according to the project data 28 held in a project-data holding unit 26.

The diagnostic-information generation unit 23, which is a diagnostic-information generation unit, generates diagnostic information 38. The diagnostic processing unit 24, which is a diagnostic processing unit, executes a diagnostic process that diagnoses the operational state of the external devices 3 and the programmable display device 2.

The storage unit 11 includes a template holding unit 25, the project-data holding unit 26, and an obtaining-information holding unit 27. The template holding unit 25, which is a template holding unit, holds therein a template for displaying a diagnostic result from the diagnostic processing unit 24 on the display unit 13.

The project-data holding unit 26 holds therein the project data 28 read from the programmable display device 2. The obtaining-information holding unit 27, which is an obtaining-information holding device, manages obtaining-information. The obtaining-information is information to be used for obtaining error information from the external device 3 when an error has occurred. The error information is information that indicates the occurrence of an error in the external device 3.

The programmable display device 2 includes a control unit 30, a storage unit 31, a memory unit 32, a display unit 33, an input unit 34, and a communication unit 35. The control unit 30, the storage unit 31, the memory unit 32, the display unit 33, the input unit 34, and the communication unit 35 are connected via a bus 36 so as to be able to communicate with each other.

The control unit 30 is a CPU. The control unit 30 controls the entire programmable display device 2. The storage unit 31 is a hard disk drive, a semiconductor storage device, or the like. The storage unit 31 stores therein various programs and data.

The memory unit 32, which is a volatile memory, is used as a working memory for the control unit 30 to execute a calculating process. The display unit 33 displays a screen according to the drawing data based on the project data 28. The display unit 33 is a liquid crystal display, for example. The input unit 34 is a keyboard, a pointing device, and the like that receive an input for the programmable display device 2. The communication unit 35 transmits and receives information to and from the computer 1 via the network 4. The communication unit 35 transmits and receives information to and from the external devices 3 via the network 5.

The project data 28 transferred from the computer 1 is stored in the storage unit 31. The project data 28 includes data for setting the layout of a screen to be displayed on the programmable display device 2, the operation, and the like. The project data 28 further includes common data 37 and the diagnostic information 38. The common data 37 is data on a comment, a component, a library, and the like used in common in the project data 28. The diagnostic information 38 is information to be used for diagnosing the operational state of the external device 3.

When correcting the project data 28 stored in the storage unit 31, the computer 1 stores the project data 28 read from the storage unit 31 in the project-data holding unit 26. The project-data management unit 20 reads the project data 28 stored in the project-data holding unit 26. The project-data management unit 20 corrects the read project data 28 according to the user operation input to the input unit 14.

When the project-data management unit 20 completes correcting the project data 28, the project-data transfer unit 21 transfers the corrected project data 28 to the programmable display device 2. With this operation, the project data 28 after being corrected is stored in the storage unit 31.

FIG. 3 is a block diagram illustrating a configuration of diagnostic information. The diagnostic information 38 includes external-device diagnostic information 41, project diagnostic information 42, and user-designated error information 43. The external-device diagnostic information 41 is information for obtaining error information from the external device 3 in which an error has occurred.

By using the external-device diagnostic information 41, the diagnostic processing unit 24 diagnoses the operational state acknowledged by the external device 3, such as a shutdown of the CPU, battery depletion, or an excessive voltage load, without using the project data and the alarm function of the programmable display device 2. The diagnostic-information generation unit 23 generates the external-device diagnostic information 41 when the external device 3 is selected to be connected to the programmable display device 2.

The project diagnostic information 42 is information for diagnosing the operational state of the external device 3 according to the project data of the programmable display device 2. The diagnostic-information generation unit 23 generates the project diagnostic information 42 when the project-data management unit 20 creates project data.

The user-designated error information 43 is information on an error designated by a user. The drawing software creates a program having an alarm function. The alarm function is a function to generate an alarm for an error designated by a user. The programmable display device 2 displays an alarm when an error, which has been set as a target to generate an alarm, occurs. The diagnostic-information generation unit 23 generates the user-designated error information 43 according to, for example, the setting specifics of the alarm function.

The diagnostic-information generation unit 23 generates the diagnostic information 38 that includes the external-device diagnostic information 41, the project diagnostic information 42, and the user-designated error information 43. The diagnostic information 38 must include at least the external-device diagnostic information 41 and the project diagnostic information 42. The diagnostic-information generation unit 23 generates the diagnostic information 38 that includes at least the external-device diagnostic information 41 and the project diagnostic information 42.

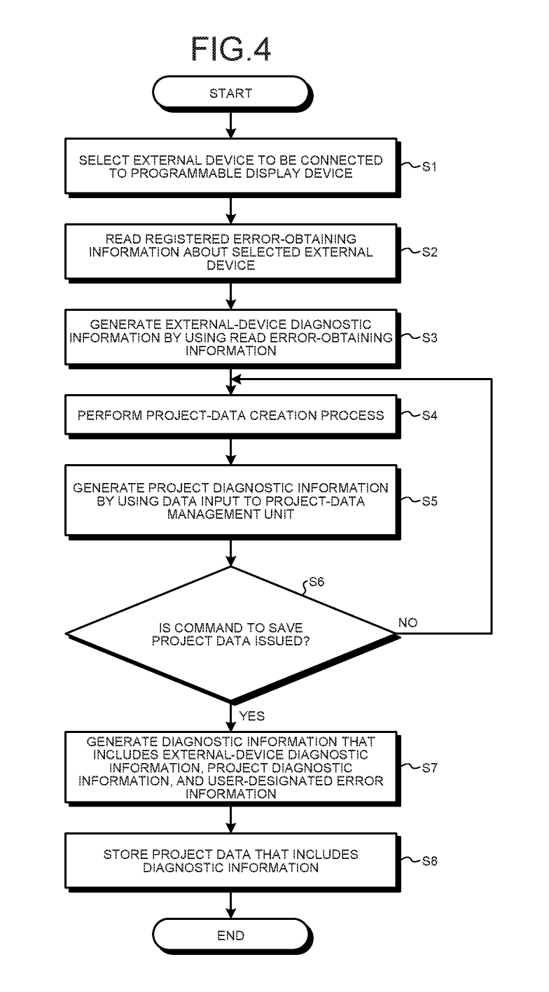

A procedure is described here in which the diagnostic-information generation unit 23 generates the diagnostic information 38 when the project data 28 is created by using the drawing software. FIG. 4 is a flowchart illustrating an example of a procedure to generate external-device diagnostic information.

The computer 1 starts creation of the project data 28 by using the function of the drawing software according to a command to start-up the drawing software. For example, the project-data management unit 20 in the computer 1 receives the selection which of the external devices 3 connected to the programmable display device 2 is selected (Step S1). A user selects any external device 3 from among the external devices 3 that are connectable to the programmable display device 2.

Obtaining-information about each of the external devices 3 that are connectable to the programmable display device 2 is registered in the obtaining-information holding unit 27. When the external device 3 is selected at Step S1 to be connected to the programmable display device 2, the diagnostic-information generation unit 23 reads the obtaining-information about the selected external device 3 registered in the obtaining-information holding unit 27 (Step S2). The diagnostic-information generation unit 23 uses the obtaining-information read at Step S2 to generate the external-device diagnostic information 41 (Step S3).

The computer 1 displays a predetermined editing screen on the display unit 13. A user operates the input unit 14 according to the specifics on the editing screen to perform screen design. The project-data management unit 20 executes a process of creating the project data 28 according to the user's input operation (Step S4).

At Step S4, when the project-data management unit 20 executes the process of creating the project data 28, the diagnostic-information generation unit 23 uses a portion of the data input to the project-data management unit 20 to execute a process of generating the project diagnostic information 42 (Step S5). When a user does not issue a command to save the created project data 28 (NO at Step S6), the computer 1 continues the process of creating the project data 28 at Step S4 and the process of generating the project diagnostic information 42 at Step S5.

During the process of creating the project data 28 or before or after the process of creating the project data 28, a user appropriately sets an alarm to be generated for a predetermined error by using the alarm function of the drawing software. The diagnostic-information generation unit 23 executes a process of generating the user-designated error information 43 according to the setting specifics of the alarm function.

When the user issues a command to save the created project data 28 (YES at Step S6), the diagnostic-information generation unit 23 merges the generated external-device diagnostic information 41, the generated project diagnostic information 42, and the generated user-designated error information 43. The diagnostic-information generation unit 23 generates the diagnostic information 38 that includes the external-device diagnostic information 41, the project diagnostic information 42, and the user-designated error information 43 (Step S7).

The project-data management unit 20 causes the diagnostic information 38 generated at Step S7 to be included in the project data 28 generated at Step S4. The project-data management unit 20 stores the project data 28 that includes the diagnostic information 38 in the memory unit 12 (Step S8). In the manner as described above, the computer 1 generates the diagnostic information 38 in which the diagnostic data is compiled as a list on a project-by-project basis.

When the user issues a command to finish creating the project data 28, the project-data transfer unit 21 transfers the project data 28 stored in the memory unit 12 to the programmable display device 2.

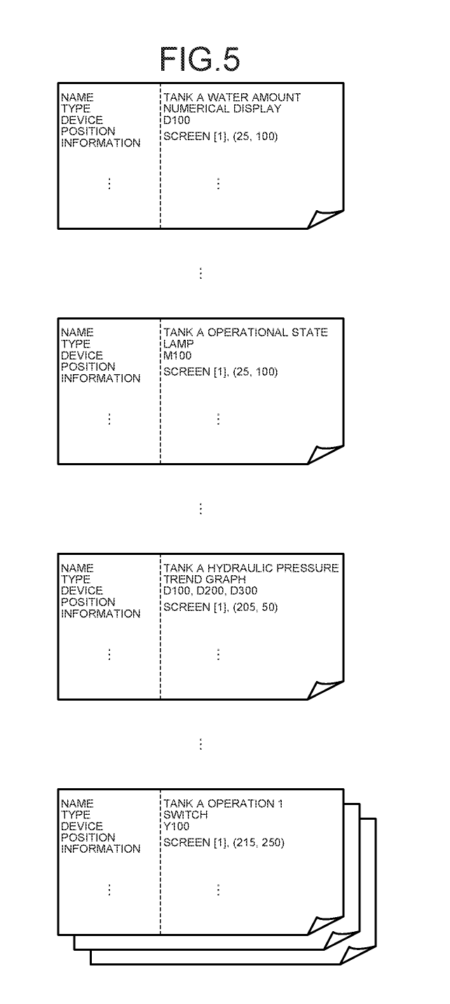

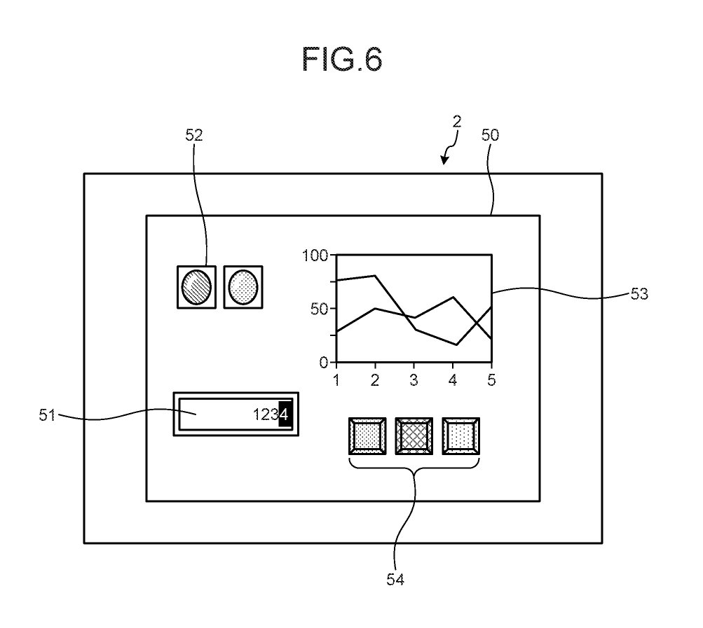

FIG. 5 is an explanatory diagram of an example of project data. FIG. 6 is a diagram illustrating an example of a screen displayed by a programmable display device according to the project data illustrated in FIG. 5. On a screen 50 illustrated in FIG. 6, objects 51 to 54 are disposed. For example, as for this screen 50, the project data 28 includes data that is set to each of the objects 51 to 54 included on the screen 50.

The project data 28 includes data “name”, “type”, “device”, and “position information” that are set to each of the objects 51 to 54, and data regarding the display of each of the objects 51 to 54.

“Name” is information for identifying each of the objects 51 to 54 within the screen 50. “Type” represents the type of each of the objects 51 to 54. “Device” represents an internal device of the programmable display device 2, which is the reference location of the specifics displayed by each of the objects 51 to 54.

For example, the object 51 numerically displays the water amount in “tank A” of the controlled device connected to a certain external device 3. The programmable display device 2 stores the data indicating this water amount in “tank A” in a device “D100”. The programmable display device 2 determines the numerical value to be displayed on the object 51 according to this data stored in “D100”.

“Position information” represents the position, where each of the objects 51 to 54 is displayed, by means of identification information on the screen and two-dimensional coordinates on the screen. For example, “screen [1]” represents the screen 50 illustrated as an example in FIG. 6. (25, 100) represents the position within the screen 50 as two-dimensional coordinates. In the project data 28, in addition to the data of each of the objects 51 to 54 as described above, data regarding the layout on the screen or the operation, for example, is also included.

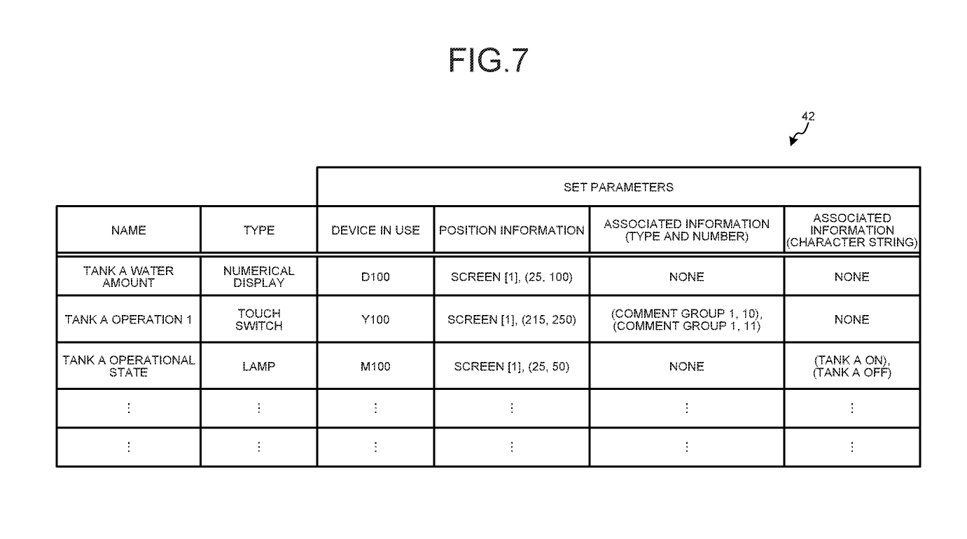

FIG. 7 is a diagram illustrating an example of project diagnostic information. The project diagnostic information 42 illustrated in FIG. 7 is generated from the project data 28 illustrated as an example in FIGS. 5 and 6. When the data regarding each of the objects 51 to 54 is set in the project-data management unit 20, the diagnostic-information generation unit 23 extracts data, which is used for diagnosing the operational state of the external device 3, from the set data.

The diagnostic-information generation unit 23 extracts each data “name”, “type”, and “set parameters”, for example, as the data to be used for the diagnosis, from the project data 28. “Set parameters” include data “device in use”, “position information”, “associated information (type and number)”, and “associated information (character string).

For example, the diagnostic-information generation unit 23 extracts the name “tank A water amount”, the type “numerical display”, the device in use “D100”, and the position information “screen [1], (25, 100)” from the data regarding the object 51.

The data in the column “associated information (type and number)” and “associated information (character string)” corresponds to the data regarding the display of each of the objects 51 to 54. The data in the column “associated information (type and number)” and “associated information (character string)” is utilized as data for retrieval at the time of diagnosis in the diagnostic information 38 described later.

When the data is set to each of the objects 51 to 54 in the project-data management unit 20, the diagnostic-information generation unit 23 individually extracts data of each of the objects 51 to 54. The diagnostic-information generation unit 23 arranges the extracted data on each row for each of the objects 51 to 54 to create a table. The table generated by arranging the extracted data is defined as the project diagnostic information 42.

When data about a certain object is set in the project-data management unit 20, the diagnostic-information generation unit 23 determines whether there is a row for the identical object in the table generated up until present. When there is no row for the identical object in the table, the diagnostic-information generation unit 23 adds a row for the extracted data about this object to the table. When there is a row for the identical object in the table, the diagnostic-information generation unit 23 updates the data on the row of this object with the data extracted at this time.

The computer 1 accumulates the extracted data in the table in conjunction with setting data to each of the objects 51 to 54 in the project-data management unit 20. With this operation, when the computer 1 generates the project data 28 in the project-data management unit 20, the computer 1 automatically generates the project diagnostic information 42 in the diagnostic-information generation unit 23.

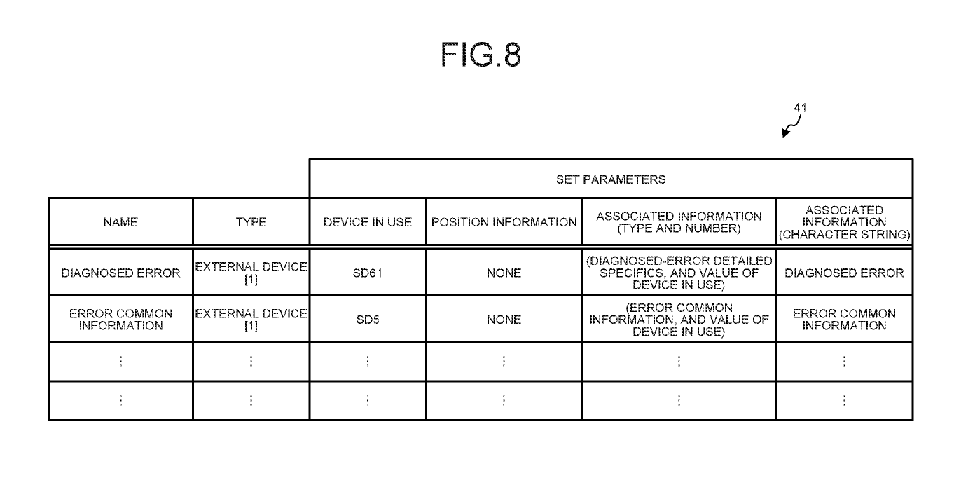

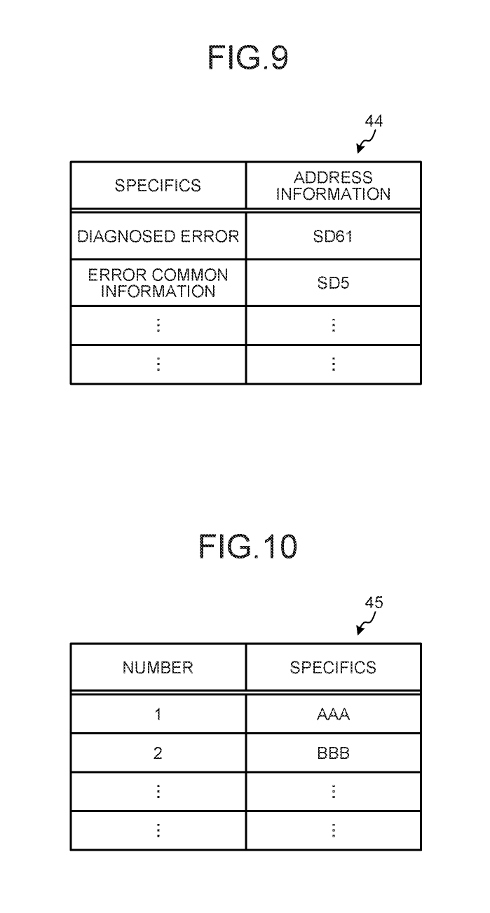

FIG. 8 is a diagram illustrating an example of external-device diagnostic information. FIG. 9 is a diagram illustrating an example of error-obtaining information. In the obtaining-information holding unit 27, error-obtaining information 44, which is illustrated as an example in FIG. 9 regarding the external devices 3 that all can be connected to the programmable display device 2, is registered.

The obtaining-information holding unit 27 manages the table that represents a relation between “specifics” of the error information and “address information” that is the reference location of the error information as the error-obtaining information 44. In the column “specifics”, the name of each error which has been set in the external device 3 is stored. The obtaining-information holding unit 27 manages the table as the error-obtaining information 44 with respect to each of the external devices 3. For example, in the external device 3 that corresponds to the error-obtaining information 44 illustrated in FIG. 9, error information about the specifics “diagnosed error” is stored in a device of this external device 3 that is represented as the address information “SD61”.

The device of the external device 3 stores therein the number that indicates the details on the error. The diagnostic-information generation unit 23 obtains this number from the device according to the external-device diagnostic information 41. Further, the diagnostic-information generation unit 23 refers to an error-detail information table to identify the detailed specifics of the error.

FIG. 10 is a diagram illustrating an example of the error-detail information table. In the obtaining-information holding unit 27, an error-detail information table 45 is registered as combination with the error-obtaining information 44. In the obtaining-information holding unit 27, the error-detail information table 45, which is illustrated as an example in FIG. 10 regarding the external devices 3 that all have a possibility to be connected to the programmable display device 2, is registered.

The error-detail information table 45 is a table that represents a relation between “number” and “specifics” that indicate the details on the error. The error-detail information table 45 is a separate table from the error-obtaining information 44, which represents the specifics indicated by the number stored in the device of the external device 3. The obtaining-information holding unit 27 manages the error-detail information table 45 with respect to each of the external devices 3.

For example, when the number “1” is read from the address information “SD61”, the diagnostic-information generation unit 23 refers to this error-detail information table 45, thereby obtaining “AAA” as the detailed specifics of the error.

When the external device 3 is selected to be connected to the programmable display device 2, the diagnostic-information generation unit 23 reads the error-obtaining information 44 about the selected external device 3 registered in the obtaining-information holding unit 27. The diagnostic-information generation unit 23 stores data on the error-obtaining information 44 read from the obtaining-information holding unit 27 in a table in the same format as the project diagnostic information 42. This table is defined as the external-device diagnostic information 41.

The diagnostic-information generation unit 23 stores data that is in the column “specifics” of the error-obtaining information 44 into the column “name” of the table defined as the external-device diagnostic information 41. The diagnostic-information generation unit 23 stores, in the column “type”, information for identifying the external device 3 as the source of this error-obtaining information 44, which is the name of the external device 3, for example.

The set parameters are set to the “name” of an error with respect to each of the external devices 3. The diagnostic-information generation unit 23 stores data in the column “address information” of the error-obtaining information 44 directly in the column “device in use”. In the column “position information”, “none” is indicated in every cell. The column “associated information (type and number)” and the column “associated information (character string)” are used to store information associated with the error information. The data in the column “associated information (type and number)” and “associated information (character string)” is utilized as data for retrieval at the time of diagnosis in the diagnostic information 38 described later.

When the external device 3 is selected to be connected to the programmable display device 2, the diagnostic-information generation unit 23 determines whether there is a row for the identical external device 3 in the table generated up until present. When there is no row for the identical external device 3 in the table, the diagnostic-information generation unit 23 adds a row for this external device 3 to the table. When there is a row for the identical external device 3 in the table, the diagnostic-information generation unit 23 updates the data on the row of this external device 3 with the data on the error-obtaining information 44 read at this time.

In conjunction with selecting the external device 3 to be connected to the programmable display device 2 in the project-data management unit 20, the computer 1 accumulates the data on the error-obtaining information 44 of this external device 3 in the table. With this operation, in conjunction with selecting the external device 3 to be connected to the programmable display device 2, the computer 1 automatically generates the external-device diagnostic information 41 in the diagnostic-information generation unit 23.

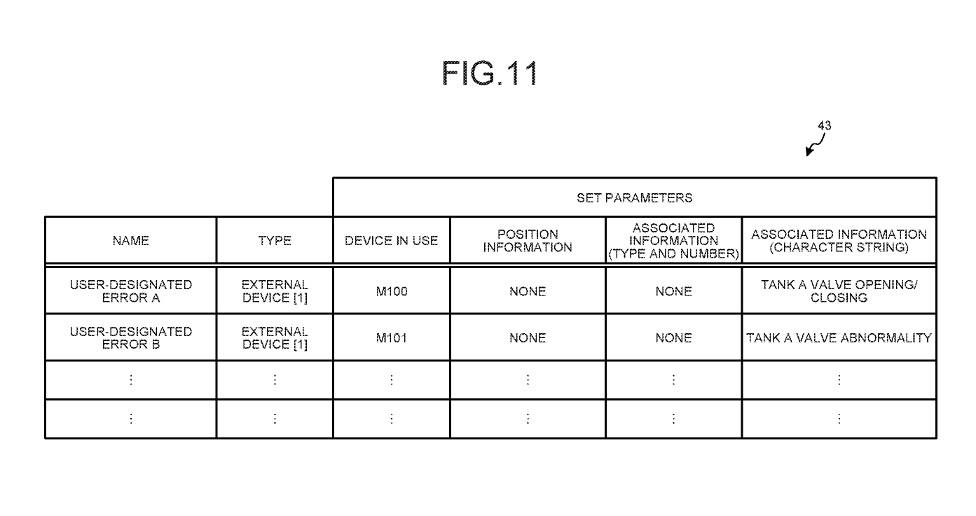

FIG. 11 is a diagram illustrating an example of user-designated error information. When a program for an alarm display is created by the alarm function of the drawing software, the diagnostic-information generation unit 23 generates the user-designated error information 43 according to the specifics of the created program.

The diagnostic-information generation unit 23 stores data extracted from this program into a table in the same format as the project diagnostic information 42. This table is defined as the user-designated error information 43.

The diagnostic-information generation unit 23 stores the name of an error in the column “name” of the table defined as the user-designated error information 43. The diagnostic-information generation unit 23 stores, in the column “type”, information for identifying the external device 3 as the error causing source, which is for example the name of the external device 3. The diagnostic-information generation unit 23 shows an internal device of the programmable display device 2, which is the reference location of the error specifics, in the column “device in use”.

In the column “position information” and “associated information (type and number)”, “none” is shown in every cell. The column “associated information (character string)” is used to store information associated with the error. The data in the column “associated information (character string)” is utilized as data for retrieval when diagnosed in the diagnostic information 38 described later.

When a program for an alarm display for a certain error is created, the diagnostic-information generation unit 23 determines whether there is a row for the identical error in the table generated up until present. When there is no row for the identical error in the table, the diagnostic-information generation unit 23 adds a row for this error to the table. When there is a row for the identical error in the table, the diagnostic-information generation unit 23 updates the data on the row of this error with the data according to the specifics of the program created at this time.

Each time a program for an alarm display is created by a user, the computer 1 accumulates data extracted from this program in the table. With this operation, the computer 1 automatically generates the user-designated error information 43 in conjunction with creating a program for an alarm display.

The diagnostic-information generation unit 23 generates the external-device diagnostic information 41, the project diagnostic information 42, and the user-designated error information 43, as tables in the same format as each other. The diagnostic-information generation unit 23 generates the diagnostic information 38 by combining the external-device diagnostic information 41, the project diagnostic information 42, and the user-designated error information 43.

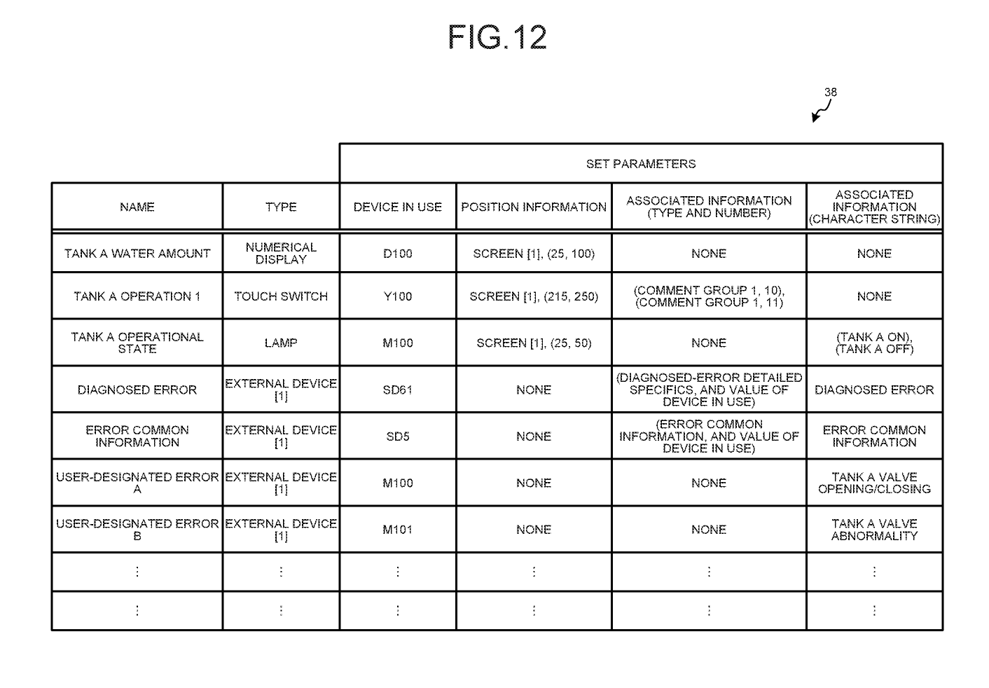

FIG. 12 is a diagram illustrating an example of diagnostic information. The diagnostic information 38 illustrated in FIG. 12 is obtained by combining the project diagnostic information 42 illustrated in FIG. 7, the external-device diagnostic information 41 illustrated in FIG. 8, and the user-designated error information 43 illustrated in FIG. 11. The diagnostic-information generation unit 23 compiles the external-device diagnostic information 41, the project diagnostic information 42, and the user-designated error information 43 into a single table. This compiled table is defined as the diagnostic information 38.

When a command to save the project data 28 on the project-data management unit 20 is issued, the diagnostic-information generation unit 23 executes a process of compiling the external-device diagnostic information 41, the project diagnostic information 42, and the user-designated error information 43 into one. With this operation, the computer 1 automatically generates the diagnostic information 38 when the project data 28 created by the project-data management unit 20 is saved.

By generating the external-device diagnostic information 41, the project diagnostic information 42, and the user-designated error information 43 as tables in the same format as each other, the diagnostic-information generation unit 23 can generate the diagnostic information 38 by a simplified operation to compile the respective tables into one. A user operates the computer 1 in order to design the screen of the programmable display device 2 and therefore, the computer 1 can automatically generate the diagnostic information 38. In the computer 1, any one of the steps in generating the diagnostic information 38 can be performed by the user operation.

The diagnostic information 38 generated by the diagnostic-information generation unit 23 is included in the project data 28 created by the project-data management unit 20. The project-data transfer unit 21 transfers the project data 28 that includes the diagnostic information 38 to the programmable display device 2. With this operation, in the storage unit 31 of the programmable display device 2, the project data 28 that includes the diagnostic information 38 is stored.

When correcting the project data 28 stored in the storage unit 31, the computer 1 stores the project data 28 read from the storage unit 31 in the project-data holding unit 26. The project-data management unit 20 corrects the project data 28 read from the project-data holding unit 26.

Corresponding to correction of the project data 28 in the project-data management unit 20, the diagnostic-information generation unit 23 corrects the diagnostic information 38. A user operates the computer 1 in order to correct the project data 28, and therefore the computer 1 can automatically correct the diagnostic information 38. In the computer 1, any one of the steps in correcting the diagnostic information 38 can be performed by the user operation.

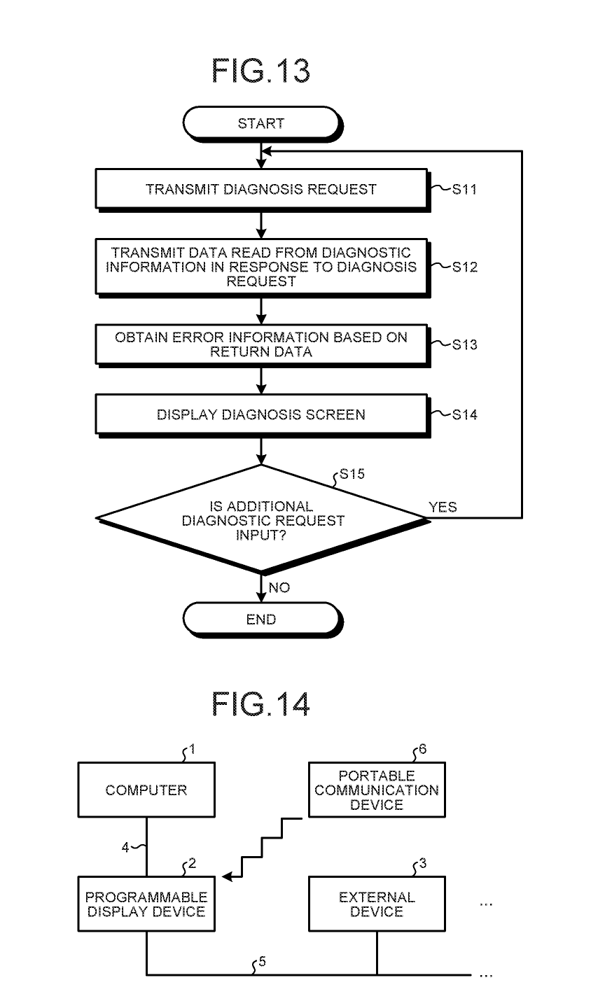

Described next is a procedure for the diagnostic processing unit 24 to diagnose the operational state of the external device 3 by using the diagnostic information 38. FIG. 13 is a flowchart illustrating an example of a procedure to diagnose an operational state of an external device by using diagnostic information.

An operator operates the input unit 14 to input a diagnosis request to the computer 1. In this diagnosis request, the operator designates the external device 3 as a target for the diagnosis. The diagnostic processing unit 24 transmits the diagnosis request to the programmable display device 2 (Step S11).

The programmable display device 2 receives the diagnosis request from the computer 1. Upon reception of the diagnosis request in the communication unit 35, the control unit 30 reads data from the diagnostic information 38 stored in the storage unit 31 in response to the diagnosis request. The control unit 30 transmits the read data as return data to the computer 1 (Step S12).

The computer 1 receives the return data from the programmable display device 2. Upon reception of the return data in the communication unit 15, the diagnostic processing unit 24 obtains error information on the basis of the return data (Step S13). The display processing unit 22 creates a diagnostic screen by using the error information obtained at Step S13 and a template read from the template holding unit 25.

The display unit 13 displays the diagnostic screen created by the display processing unit 22 (Step S14). The diagnostic screen is a screen that shows, as the specifics, a result of the diagnosis in the diagnostic processing unit 24. An operator determines whether an additional diagnosis is required according to the specifics on the diagnostic screen displayed on the display unit 13. When the operator determines that an additional diagnosis is required, the operator inputs an additional diagnosis request to the computer 1.

When the additional diagnosis request is input to the computer 1 (YES at Step S15), the diagnostic processing unit 24 transmits the additional diagnosis request to the programmable display device 2 (Step S11). Thereafter, Step S12 and the subsequent steps are repeated. When the additional diagnosis request is not input to the computer 1 (NO at Step S15), the diagnostic processing unit 24 finishes the diagnosis.

As a specific example, given that “external device [1]” that is one of the external devices 3 connected to the programmable display device 2 is designated as a target for the diagnosis. At Step S11, the diagnostic processing unit 24 transmits a diagnosis request for diagnosing the error occurrence state in “external device [1]” to the programmable display device 2.

When the programmable display device 2 receives this diagnosis request, the control unit 30 reads “SD61” that is the address of the device in use related to the diagnosed error from the diagnostic information 38, for example. At Step S12, the control unit 30 transmits the read address “SD61” to the computer 1.

When the computer 1 receives this “SD61”, the diagnostic processing unit 24 obtains the value stored in the device “SD61” of “external device [1]” from “external device [1]”. Instead of transmitting “SD61” to the computer 1 in response to the diagnosis request, the programmable display device 2 can transmit the value stored in “SD61” directly to the computer 1.

In the case where the programmable display device 2 is capable of reading the value stored in a device of the external device 3, the diagnostic processing unit 24 can obtain the value in the device of the external device 3 from the programmable display device 2.

When a new external device 3 is connected to the programmable display device 2, the diagnostic information 38, which includes the external-device diagnostic information 41 about a communication device that performs communication between the new external device 3 and the programmable display device 2 and about the concerning external device 3, is transferred to the programmable display device 2. Upon reception of the value in the device (for example, “SD61”) of the external device 3, the communication device reads error information with respect to each of the external devices 3 on the basis of the diagnostic information 38 stored in the storage unit 31.

The communication device stores the read error information in the area of the storage unit 31 at a predetermined internal address (a virtual address). For example, the control unit 30 includes an address conversion unit (not illustrated) that converts between the virtual address and the address of the device of the external device 3 (a physical address).

When the address conversion unit receives a request from the computer 1 to read the value in the device of the external device 3, this address conversion unit converts the received address (a physical address) into a virtual address. The control unit 30 returns the value read from this virtual address as error information to the computer 1.

Although the area, where error information with respect to each of the external devices 3 is stored, is not determined statically, the programmable display device 2 is still capable of dynamically storing the error information with respect to each of the external devices 3 by using the virtual address. With this configuration, the programmable display device 2 is capable of accurately outputting error information in response to a diagnosis request in which the physical address of each of the external devices 3 is designated. When a new external device 3 is added to the programmable display device 2, the control system can easily perform settings so as to be able to obtain error information from the new external device 3.

For example, in a case where no error has occurred, “external device [1]” stores “0” in “SD61”. For example, in a case where an error has occurred, “external device [1]” stores an integer equal to or greater than “1” in “SD61” according to what the error is. When the diagnostic processing unit 24 obtains “0” from “SD61”, it determines that no error has occurred in “external device [1]”.

When the diagnostic processing unit 24 obtains the value other than “0” from “SD61”, it reads the detailed specifics of the error indicated by the obtained number from the obtaining-information holding unit 27. For example, when the diagnostic processing unit 24 obtains “1” from “SD61”, it reads the error specifics “AAA” corresponding to the number “1” from the error-detail information table 45 regarding “external device [1]”, registered in the obtaining-information holding unit 27.

The diagnostic processing unit 24 obtains error information “AAA” on the basis of the data “SD61” read from the diagnostic information 38 in response to the diagnosis request. In the manner described above, the diagnostic processing unit 24 automatically obtains error information in response to the operator's input of a diagnosis request.

The display processing unit 22 reads a template according to the type “external device [1]” corresponding to “SD61” from the template holding unit 25. The display processing unit 22 uses the template read from the template holding unit 25 to create a diagnostic screen that includes, as the specifics, the error information “AAA” obtained by the diagnostic processing unit 24.

Other than the error information, each data of the name, the type, and the set parameters stored in the diagnostic information 38, can also be displayed on the diagnostic screen. For example, along with the error information “AAA” obtained from the device in use “SD61”, the name “diagnosed error”, the type “external device [1]”, the device in use “SD61” that is a set parameter, and other data can also be displayed on the diagnostic screen.

On the basis of the data displayed on the diagnostic screen, an operator can request an additional diagnosis to retrieve data that includes a predetermined keyword from the diagnostic information 38. For example, an operator instructs the computer 1 to retrieve M100 as an additional diagnosis request. The diagnostic processing unit 24 transmits the additional diagnosis request to the programmable display device 2 to instruct it to retrieve M100.

When the programmable display device 2 receives this additional diagnosis request, the control unit 30 reads data that includes “M100” as a set parameter from the diagnostic information 38. The control unit 30 transmits the read data as return data to the computer 1. The display processing unit 22 displays a list of data that includes “M100” as a set parameter on the diagnostic screen with a predetermined template. On the basis of the data displayed on the diagnostic screen, an operator can further request an additional diagnosis to retrieve the data again.

For example, upon obtaining a diagnostic result of a certain external device 3, the computer 1 performs an additional diagnosis so as to retrieve the diagnostic information 38 again by using a keyword selected from this diagnostic result, and therefore can diagnose an error associated with a plurality of external devices 3.

In the case where information regarding the display of an object is included in the set parameters of the diagnostic information 38, a simplified display of the object can also be included on the diagnostic screen. The simplified display is generated by using the display-related data on the set parameters. On the diagnostic screen, a diagnostic result can be displayed around the simplified display of the object.

Generally, each of the external devices 3 uses a different device to store data that indicates the operational state, such as error information. Each of the external devices 3 uses a different method to access the data that indicates the operational state. Given that obtaining and displaying of the error information is executed by a program of the programmable display device 2, a dedicated program to each of the external devices 3 is needed. Aside from this, in order to identify the operational state of each external device 3, an operator obtains error information according to each individual access method for each external device 3.

In the present embodiment, the computer 1 automatically obtains and displays error information according to the operator's input of a diagnosis request. Even when an operator does not know the access method that differs between the external devices 3, the computer 1 can still obtain data that indicates the operational state of each external device 3 connected to the programmable display device 2.

The computer 1 can diagnose the external device 3 by simplified work, as compared to the case where a peripheral device is connected to each external device 3 where the peripheral device has dedicated diagnostic software for the external device 3 installed therein. Even in a case where it is difficult to place a diagnostic peripheral device near the external device 3, the diagnostic method of the present embodiment is still useful.

By using the diagnostic information 38 that includes the external-device diagnostic information 41, the project diagnostic information 42, and the user-designated error information 43, the computer 1 can perform a diagnosis collectively by using the error information on the external device 3, and the project data and the alarm function of the programmable display device 2. In a diagnosis according to the user-designated error information 43, a device and a memory are used, which are capable of reading and writing error-related information by setting of a user.

In contrast thereto, a device to be used in a diagnosis according to the external-device diagnostic information 41 cannot write error-related information by setting of a user, but is only capable of reading the information. The information stored in the device of the external device 3 as described above is referred to as “device's error information”, “environmental information”, or the like.

For example, when an error has occurred that the alarm function is capable of handling, the computer 1 displays a result of the diagnosis according to the user-designated error information 43 on the diagnostic screen. According to the specifics displayed on the diagnostic screen, an operator requests an additional diagnosis targeted at the external device 3 and therefore can obtain further detailed information about the cause of the error.

Upon a diagnosis request, the computer 1 accesses the diagnostic information 38 stored in the programmable display device 2 and then can perform a diagnosis by using the error information on the external device 3, and the project data and the alarm function of the programmable display device 2. The computer 1 can reduce the number of access operations as compared to the case where an individual diagnosis request to the database of each external device 3, in addition to the project data, is required.

With the configuration described above, the drawing apparatus and the control system are capable of easily obtaining detailed information regarding a problem having occurred in a control system provided with the programmable display device 2 and the external devices 3, and can work efficiently on figuring out the cause of the problem and on resuming the operation. By applying the drawing apparatus, the control system is capable of figuring out the cause of the occurrence of a problem and of resuming the operation promptly and therefore can reduce the time during which the system is not operational (downtime).

Next, a display example of the screen of the display unit 13 is described. When starting a diagnosis, the computer 1 displays an error check screen on the display unit 13, for example. The diagnostic processing unit 24 in the computer 1 also can start a diagnosis according to a keyword selected by the operator from the error check screen. The computer 1 receives operator's keyword selection as a diagnosis request.

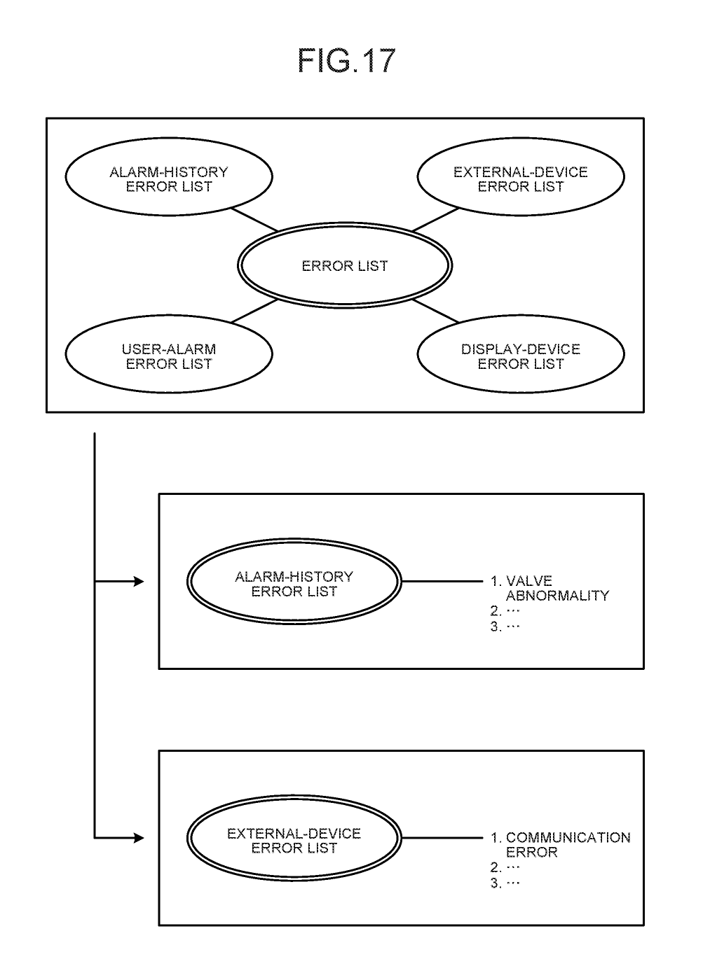

FIG. 17 is an explanatory diagram of a transition of the error check screen. Errors to be checked are categorized into an alarm-history error, a user-alarm error, an external-device error, and a display-device error. The alarm-history error is an error for which the programmable display device 2 has previously displayed an alarm by using the alarm function. The user-alarm error is an error designated by a user by using the alarm function. The external-device error is an error that occurs in the external device 3. The display-device error is an error of the programmable display device 2.

On the error check screen, first, each category name is displayed, as “error list”, “alarm-history error list”, “user-alarm error list”, “external-device error list”, and “display-device error list”. When an operator selects any one of these category names, the error check screen changes the display into a list of errors included in the selected category.

For example, when “alarm-history error list” is selected from the initial error check screen, the error check screen changes the display to a list of alarm-history errors. For example, when an operator selects “1. valve abnormality” from the list of alarm-history errors, the diagnostic processing unit 24 receives this selection as a diagnosis request. The diagnostic processing unit 24 transmits a command to read data associated with “valve abnormality” from the diagnostic information 38 as a diagnosis request to the programmable display device 2. Upon reception of this diagnosis request, the programmable display device 2 reads data in which “valve abnormality” is included in any of the name, type, and set parameters from the diagnostic information 38.

For example, when “external-device error list” is selected from the initial error check screen, the error check screen changes the display to a list of external-device errors. For example, when an operator selects “1. communication error” from the list of external-device errors, the diagnostic processing unit 24 receives this selection as a diagnosis request.

The diagnostic processing unit 24 transmits a command to read data associated with “communication error” from the diagnostic information 38 as a diagnosis request to the programmable display device 2. Upon reception of this diagnosis request, the programmable display device 2 reads data, in which “communication error” is included in any of the name, type, and set parameters from the diagnostic information 38.

Aside from that, given that, for example, “diagnosed error” of “external device [1]” (not illustrated in FIG. 17) is selected from the list of external-device errors. The programmable display device 2 reads data that includes the type “external device [1]” and the name “diagnosed error” from the diagnostic information 38 illustrated in FIG. 12, for example. In this data, the device in use “SD61” is included.

The programmable display device 2 transmits the read data to the computer 1. The computer 1 displays the diagnostic screen according to the data received from the programmable display device 2.

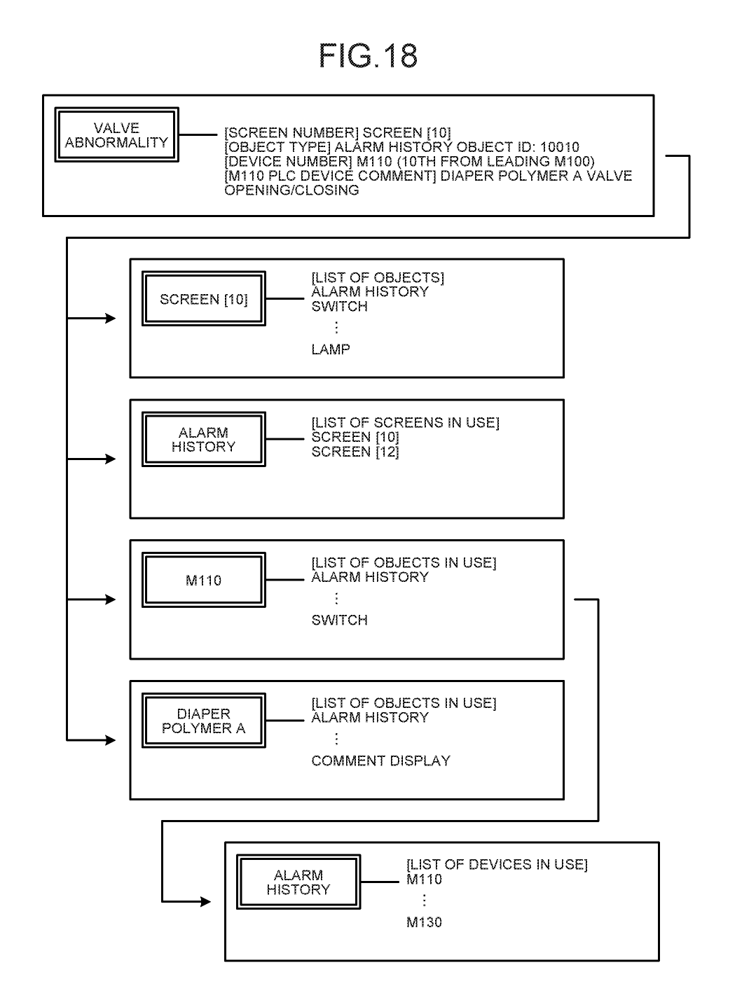

FIG. 18 is an explanatory diagram of a transition of the diagnostic screen. The diagnostic screen illustrated in FIG. 18 illustrates an example of displaying data that includes “valve abnormality”. The display processing unit 22 processes the data that includes “valve abnormality” according to the template read from the template holding unit 25. On the diagnostic screen, the data that includes “valve abnormality” as a set parameter, for example, is displayed according to the template read out from the template holding unit 25.

On the diagnostic screen, subsequent to “valve abnormality” as a keyword of the present diagnosis, a list of constituent elements of the keyword is displayed. This list of constituent elements is converted from the data read from the diagnostic information 38 and is displayed according to the template.

A constituent element can be selected from the list of constituent elements of the keyword on the diagnostic screen. The diagnostic processing unit 24 receives operator's selection of a constituent element as an additional diagnosis request. For example, when an operator selects the constituent element “screen [10]” from the list of constituent elements, the diagnostic processing unit 24 receives this selection as an additional diagnosis request. Upon reception of this additional diagnosis request, the programmable display device 2 reads data, in which “screen [10]” is included in any one of the name, type, and set parameters from the diagnostic information 38.

The display processing unit 22 processes the data that includes “screen [10]” according to the template read from the template holding unit 25. The diagnostic screen changes the initial display to a display of the data that includes “screen [10]” as a keyword of the present diagnosis. As a list of constituent elements of “screen [10]”, a list of objects is displayed, for example.

On the diagnostic screen for “valve abnormality”, other constituent elements can be selected, which are, for example, “alarm history”, “M110”, and “diaper polymer A”. For example, when “M110” is selected, the diagnostic screen changes the initial “valve abnormality” display to a display of the data that includes “M110” as a keyword of the present diagnosis. As a list of constituent elements of “M110”, a list of objects in use is displayed, for example.

On the diagnostic screen, a constituent element can further be selected from the list of constituent elements of “M110”. For example, when an operator selects the constituent element “M110” from the list of constituent elements, the diagnostic processing unit 24 receives this selection as an additional diagnosis request. For example, when “alarm history” is selected, the diagnostic screen changes the “M110” display to a display of the data that includes “alarm history” as a keyword of the present diagnosis. As a list of constituent elements of “alarm history”, a list of devices in use is displayed, for example.

In the manner as described above, the computer 1 shifts the diagnostic screen of the display unit 13 into a display in response to a diagnosis request. An operator can check an error in the control system by a simplified operation to select a displayed keyword. The computer 1 performs keyword retrieval in the diagnostic information 38 and thus can obtain information, which is useful for figuring out the cause of an error and for resuming the operation, collectively from the external-device diagnostic information 41, the project diagnostic information 42, and the user-designated error information 43.

### Second Embodiment

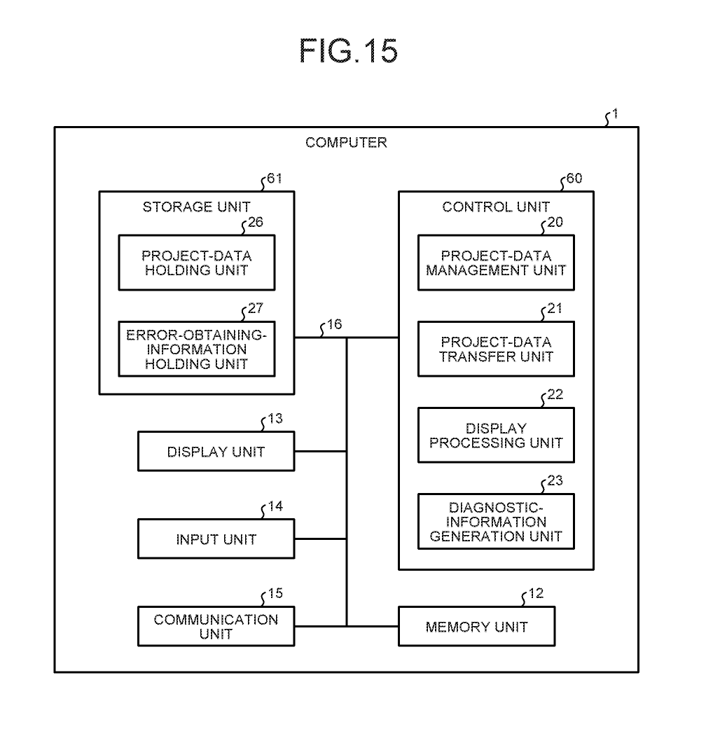

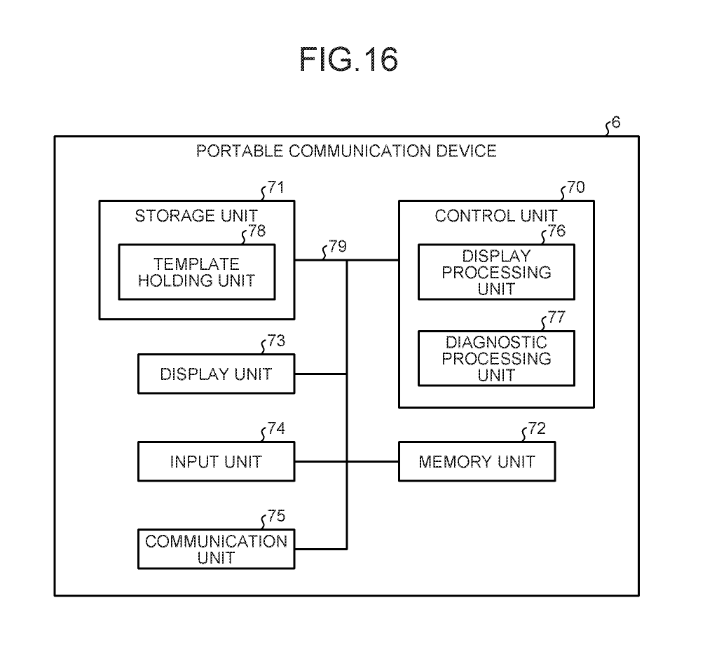

FIG. 14 is a block diagram illustrating a control system that includes a drawing apparatus and a diagnostic apparatus according to a second embodiment of the present invention. FIG. 15 is a block diagram illustrating a configuration of a computer as the drawing apparatus included in the control system illustrated in FIG. 14. FIG. 16 is a block diagram illustrating a configuration of a portable communication device as the diagnostic apparatus included in the control system illustrated in FIG. 14. Elements identical to those of the first embodiment are denoted with like reference signs, and redundant descriptions thereof will be omitted.

The control system includes the computer 1, the programmable display device 2, the external device 3, and a portable communication device 6. Similar to the first embodiment, any number of the external devices 3 can be connected to the programmable display device 2. The programmable display device 2 and the portable communication device 6 are capable of wirelessly communicating with each other by using the Ethernet®, for example.

The computer 1 includes a control unit 60, a storage unit 61, the memory unit 12, the display unit 13, the input unit 14, and the communication unit 15. Drawing software installed in the computer 1 of the second embodiment has a diagnostic-information generating function that is the same as in the drawing software of the first embodiment.

Each function included in the drawing software is performed by using the control unit 60 and the storage unit 61. The control unit 60 includes the project-data management unit 20, the project-data transfer unit 21, the display processing unit 22, and the diagnostic-information generation unit 23. The storage unit 61 includes the project-data holding unit 26 and the obtaining-information holding unit 27.

The portable communication device 6 is hardware having diagnostic processing software installed therein. This diagnostic processing software has a diagnostic processing function among the respective functions of the drawing software in the first embodiment. The diagnostic apparatus of the present embodiment is the portable communication device 6 having the diagnostic processing software installed therein. The portable communication device 6 is a smartphone or a tablet, for example.

The portable communication device 6 includes a control unit 70, a storage unit 71, a memory unit 72, a display unit 73, an input unit 74, and a communication unit 75. The control unit 70, the storage unit 71, the memory unit 72, the display unit 73, the input unit 74, and the communication unit 75 are connected via a bus 79 so as to be able to communicate with each other. Each function included in the diagnostic processing software is performed by using the control unit 70 and the storage unit 71.

The control unit 70 is a CPU that controls the entire portable communication device 6. The storage unit 71 is a hard disk drive, a semiconductor storage device, or the like. The storage unit 71 stores therein various programs and data. The memory unit 72, which is a volatile memory, is used as a work memory for the control unit 70 to execute a calculating process.

The display unit 73 displays a screen according to the control executed by the control unit 70. The display unit 73 is a liquid crystal display, for example. The input unit 74 is a pointing device that receives an input operation to the computer 1, and it is a touch pad for example. The communication unit 75 transmits and receives information to and from the programmable display device 2.

The control unit 70 includes a display processing unit 76 and a diagnostic processing unit 77. The display processing unit 76 executes a process for the displaying on the display unit 73. The diagnostic processing unit 77, which is a diagnostic processing unit, executes a diagnostic process that diagnoses the operational state of the external devices 3 and the programmable display device 2.

The storage unit 71 includes a template holding unit 78. The template holding unit 78, which is a template holding unit, holds therein a template for displaying a diagnostic result in the diagnostic processing unit 77 on the display unit 73.

Next, a procedure is described for the diagnostic processing unit 77 to diagnose the operational state of the external device 3 by using the diagnostic information 38 (see FIG. 2). The diagnostic processing unit 77 diagnoses the operational state of the external device 3 according to the procedure illustrated in FIG. 13, for example, similar to the diagnostic processing unit 24 included in the drawing apparatus of the first embodiment. With reference to the flowchart illustrated in FIG. 13, the diagnostic procedure in the diagnostic processing unit 77 is described.

An operator operates the input unit 74 to input a diagnosis request to the portable communication device 6. In this diagnosis request, the operator designates the external device 3 as a diagnosis target. The diagnostic processing unit 77 transmits the diagnosis request to the programmable display device 2 (Step S11).

The programmable display device 2 receives the diagnosis request from the portable communication device 6. Upon reception of the diagnosis request in the communication unit 35, the control unit 30 reads data from the diagnostic information 38 stored in the storage unit 31 in response to the diagnosis request. The control unit 30 transmits the read data as return data to the portable communication device 6 (Step S12).

The portable communication device 6 receives the return data from the programmable display device 2. Upon reception of the return data in the communication unit 75, the diagnostic processing unit 77 obtains error information on the basis of the return data (Step S13). The display processing unit 76 creates a diagnostic screen by using the error information obtained at Step S13, and a template read from the template holding unit 78.

The display unit 73 displays the diagnostic screen created by the display processing unit 76 (Step S14). The diagnostic screen is a screen that illustrates, as the specifics, a result of the diagnosis in the diagnostic processing unit 77. An operator determines whether an additional diagnosis is required according to the specifics on the diagnostic screen displayed on the display unit 73. When the operator determines that an additional diagnosis is required, this operator inputs an additional diagnosis request to the portable communication device 6.

When the additional diagnosis request is input to the portable communication device 6 (YES at Step S15), the diagnostic processing unit 77 transmits the additional diagnosis request to the programmable display device 2 (Step S11). Thereafter, Step S12 and the subsequent steps are repeated. In the manner as described above, the portable communication device 6 diagnoses the operational state of the external device 3.

In the present embodiment, the portable communication device 6 automatically obtains and displays error information according to the operator's input of a diagnosis request. Even when an operator does not know the access method that differs between the external devices 3, the portable communication device 6 can still obtain data that indicates the operational state of each external device 3 connected to the programmable display device 2.

Similar to the first embodiment, the control system of the present embodiment is capable of easily obtaining detailed information regarding a problem having occurred in a control system including the programmable display device 2 and the external devices 3 and can work efficiently on figuring out the cause of the problem, and resuming the operation. An operator who carries the portable communication device 6 operates this portable communication device 6 and thus can diagnose the operational state of each external device 3 at any location. For example, an operator can perform a diagnosis at a remote location away from the computer 1, the programmable display device 2, and each external device 3.

The portable communication device 6 can also display an error check screen and a diagnostic screen similar to the computer 1 of the first embodiment. An operator can check an error in the control system by a simplified operation to select a keyword displayed on the portable communication device 6.

### REFERENCE SIGNS LIST

1 computer, 2 programmable display device, 3 external device, 4, 5 network, 6 portable communication device, 10 control unit, 11 storage unit, 12 memory unit, display unit, 14 input unit, 15 communication unit, bus, 20 project-data management unit, 21 project-data transfer unit, 22 display processing unit, 23 diagnostic-information generation unit, 24 diagnostic processing unit, template holding unit, 26 project-data holding unit, obtaining-information holding unit, 28 project data, control unit, 31 storage unit, 32 memory unit, 33 display unit, 34 input unit, 35 communication unit, 36 bus, 37 common data, 38 diagnostic information, 41 external-device diagnostic information, 42 project diagnostic information, 43 user-designated error information, 44 error-obtaining information, 45 error-detail information table, 51 to 54 object, 60 control unit, 61 storage unit, 70 control unit, 71 storage unit, memory unit, 73 display unit, 74 input unit, 75 communication unit, 76 display processing unit, 77 diagnostic processing unit, 78 template holding unit, 79 bus.

1. A drawing apparatus that creates drawing data to be executed by a programmable display device connected to an external device, the drawing apparatus comprising:
a project-data creator that creates project data that is a basis for the drawing data;
a project-data transferrer that transfers the project data created by the project-data creator to the programmable display device;
a diagnostic-information generator that generates diagnostic information for diagnosing an operational state of the external device on the basis of the diagnostic information; and
an obtaining-information holder that holds therein obtaining-information for obtaining error information indicating specifics of an error that has occurred in the external device, wherein
the obtaining-information about each of external devices that are connectable to the programmable display device is registered in the obtaining-information holder,
when an external device that is connected to the programmable display device is selected from among the external devices, the diagnostic-information generator
reads the obtaining-information about the selected external device, which is registered in the obtaining-information holder, and
generates the diagnostic information by using the read obtaining-information, and
the project-data transferrer transfers the project data that includes the diagnostic information generated by the diagnostic-information generator to the programmable display device.

2. The drawing apparatus according to claim 1, wherein
when an external device connected to the programmable display device is selected, the diagnostic-information generator generates external-device diagnostic information for obtaining the error information by using the read obtaining-information,
when the project-data creator creates the project data, the diagnostic-information generator generates project diagnostic information for diagnosing the operational state according to the project data by using data that is input to the project-data creator, and
the diagnostic-information generator generates the diagnostic information that includes the external-device diagnostic information and the project diagnostic information.

3. The drawing apparatus according to claim 2, wherein the diagnostic-information generator generates the external-device diagnostic information and the project diagnostic information as tables in formats that are identical to each other.

4. The drawing apparatus according to claim 1, further comprising a diagnostic processing unit that diagnoses an operational state of the external device connected to the programmable display device, wherein
the diagnostic processing unit
transmits a diagnosis request, which is targeted at any one of the external devices connected to the programmable display device, to the programmable display device, and
obtains the error information on the basis of data that has been read from the diagnostic information held in the programmable display device in response to the diagnosis request.

5. The drawing apparatus according to claim 4, further comprising:
a display unit that displays a diagnostic screen that illustrates as content a result of a diagnosis in the diagnostic processing unit; and
a template holder, that holds therein a template for the diagnostic screen.

6. A control system comprising:
a programmable display device;
an external device that is connected to the programmable display device; and
a drawing apparatus that creates drawing data to be executed by the programmable display device, wherein
the drawing apparatus includes
a project-data creator that creates project data that is a basis for the drawing data,
a project-data transferrer that transfers the project data created by the project-data creator to the programmable display device,
a diagnostic-information generator that generates diagnostic information for diagnosing an operational state of the external device according to the diagnostic information, and
an obtaining-information holder that holds therein obtaining-information for obtaining information indicating specifics of an error that has occurred in the external device,
in the obtaining-information holder, the obtaining-information about each of external devices, which are connectable to the programmable display device, is registered,
when an external device, which is connected to the programmable display device, is selected from among the external devices, the diagnostic-information generator
reads obtaining-information about the selected external device registered in the obtaining-information holder and
generates the diagnostic information by using the read obtaining information,
the project-data transferrer transfers the project data that includes the diagnostic information generated by the diagnostic-information generator to the programmable display device, and
the programmable display device holds therein the project data that includes the diagnostic information and that has been transferred by the project-data transferrer.

7. The control system according to claim 6, wherein
when an external device connected to the programmable display device is selected, the diagnostic-information generator generates external-device diagnostic information for obtaining the error information by using the read error-obtaining information,
when the project-data creator creates the project data, the diagnostic-information generator generates project diagnostic information for diagnosing the operational state according to the project data by using data that is input to the project-data creator, and
the diagnostic-information generator generates the diagnostic information that includes the external-device diagnostic information and the project diagnostic information.

8. The control system according to claim 6, wherein
the drawing apparatus further includes a diagnostic processing unit that diagnoses an operational state of the external devices connected to the programmable display device,
the diagnostic processing unit
transmits a diagnosis request, which is targeted at any one of the external devices connected to the programmable display device, to the programmable display device and
obtains the error information on the basis of return data from the programmable display device that has responded to the diagnosis request, and
the programmable display device transmits data, read from the diagnostic information in response to the diagnosis request, to the drawing apparatus as the return data.

9. The control system according to claim 6, further comprising a diagnostic apparatus that diagnoses an operational state of the external devices, wherein
the diagnostic apparatus includes a diagnostic processing unit that diagnoses an operational state of the external devices connected to the programmable display device,
the diagnostic processing unit transmits a diagnosis request, targeted at any one of the external devices connected to the programmable display device, to the programmable display device and obtains the error information on the basis of return data from the programmable display device that has responded to the diagnosis request, and
the programmable display device transmits data, read from the diagnostic information in response to the diagnosis request, to the diagnostic apparatus as the return data.

10. The control system according to claim 9, wherein
the diagnostic apparatus further includes
a display unit that displays a diagnostic screen that illustrates as content a result of a diagnosis in the diagnostic processing unit, and
a template holder that holds therein a template for the diagnostic screen.
